(19) United States
(12) Patent Application Publication
(10) Pub. No.: US 2006/0244415 A1
(43) Pub. Date: Nov. 2, 2006

(54) Battery back-up for vending machine lock

(76) Inventors: William D. Denison, Lake Zurich, IL (US); Gary L. Myers, Monee, IL (US); Calin V. Roatis, Long Grove, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/991,696

(22) Filed: Nov. 18, 2004

Related U.S. Application Data
(60) Provisional application No. 60/523,505, filed on Nov. 18, 2003.

(51) Int. Cl. H02J 7/00

(52) U.S. Cl. 320/112; 340/5.73; 292/201; 455/20; 340/693.2

(57) ABSTRACT

A back-up portable power supply for operating a multiplicity of electronically locking systems on vending machines or similar enclosures. The power supply can include optional access control, control actuator for saving power, a boost circuit, recharge capability and status annunciation. It preferably is operational along with a wireless electronic key and a management system.

### RELATED APPLICATION

This is a continuation of U.S. Provisional Application 60/523,505, filed Nov. 18, 2003.

### FIELD OF THE INVENTION

This invention pertains generally to electronic lock systems and, more particularly, to a battery back-up for electronic vending machine locks or similar enclosures.

### BACKGROUND OF THE INVENTION

The invention provides an external battery back-up for powering an electronic vending machine lock accessible, for example, by a wireless electronic key.

Mechanical locks and keys have been used principally on vending machines for over the past 50 years. Recently, efforts have been successfully made to provide electronic locking systems for vending machines. Examples are Roatis et al. U.S. Pat. Nos. 6,575,504 and 6,581,986, assigned to the assignee of the present invention. Other examples of attempts by others are shown in U.S. Pat. Nos. 6,525,644 and 6,496,101, where a combined data/power link was proposed that further included a spare power link accessible from the outside of a vending machine door. Earlier devices are known where a combined digital lock key with power provision powered both the electromechanical lock and key. See Falk, U.S. Pat. No. 4,594,637. What is required, however, is an electronic key and management system to overcome the management and security problems associated with mechanical locks and keys and separate portable power supply means to enable the locking mechanism.

An electronic lock with a no-point of attack and a wireless interface to the electronic key is a particular advantage due to the amount of physical attack and vandalism on vending machines today.

An electronic lock system typically would have its primary electrical power available from the vending machine. This is typically the same power source to power the lights, vending control board and mechanism, coinage and bill acceptors, etc.

It is an advantage to provide an electronic lock with keyless entry (or no point of contact with keys) and provide access to a back-up power connection that will allow power to be applied to the lock even if the primary power source is missing.

It is also an advantage to provide an electronic portable power source that will allow power to be applied to the lock even if the primary power source is missing.

It is another advantage to make the battery back-up system portable so it can be used on more than one vendor, so that one battery pack per vending machine is not required, and so that maintaining batteries inside each vendor is not required.

If the vendor door is locked and if electronic power is not available at the vending machine and if there is no access to the lock to apply power to it via an interface to the electronic key (because the key to lock interface is wireless), than a special back-up power access point and interface should be required in order to open the vendor.

### BRIEF SUMMARY OF THE INVENTION

The invention provides a battery back-up power system with the forgoing advantages and overcomes the disadvantages and undesirable aspects of former devices and attempts to use electronic locks for vending machines.

Accordingly, it is an object of invention to provide an electronic interface to a vending machine electronic lock that can be accessed while the door is closed and locked.

It is another object of the invention to provide a portable power source that when connected to the vending machine will supply power to the lock but does not automatically provide access control for the lock.

It is yet another object of the invention to provide a boost circuit to step-up the voltage supplied to the lock.

It is a further object of the invention to provide a control switch or actuator to send the electronic voltage and current to the lock when actuated.

A related object of the invention to provide methods of replacing the batteries and recharging the batteries.

It is a further object of the invention to provide a method of annunciating if and when the battery voltage or current is low and needs replacement and/or recharging.

These and other advantages of the invention, as well as additional inventive features, will be apparent from the description of the invention provided herein.

### BRIEF DESCRIPTION OF THE DRAWINGS

FIG. 1 is a diagrammatic view of a portable power source according to the present invention for connection to a multiplicity of vending machines;

FIG. 2 is a diagrammatic view of the power source electrical circuit and interface;

FIG. 3 is a flow chart showing the access lock operation; and

FIG. 4 is a flow chart showing the un-lock operation with the back-up power source.

### DETAILED DESCRIPTION OF THE INVENTION

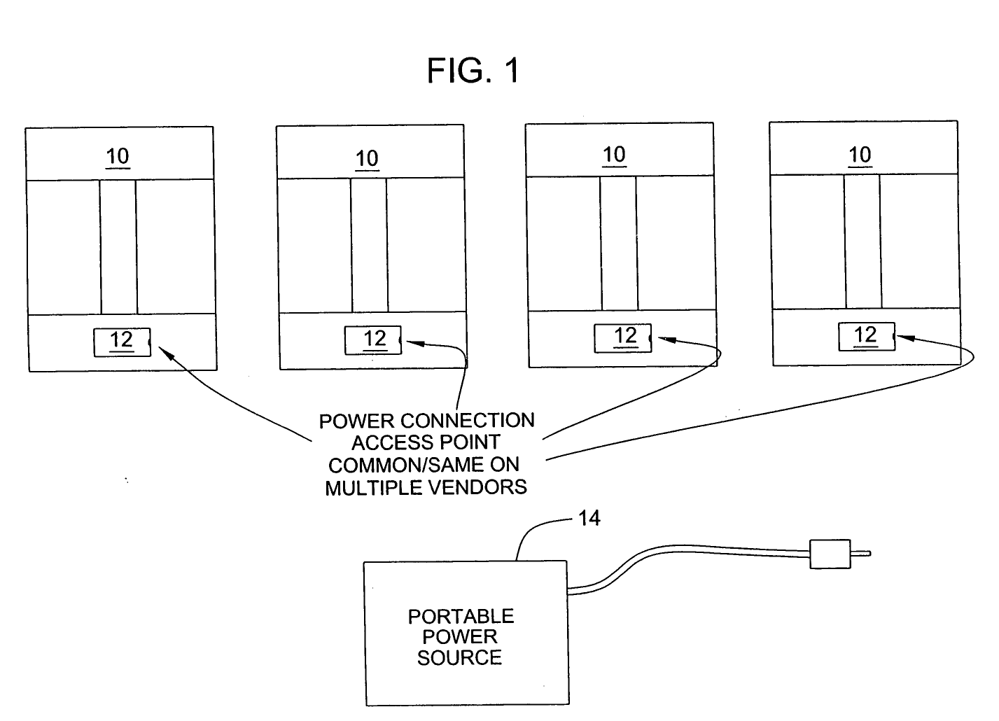

In accordance with the invention, temporary power is provided to the lock in the event power to the lock is not made available by the vending machine. In FIG. 1, each vending machine 10 has a common interface 12 to the back-up system 14. In this case, the power connection is located in the product chute to make it difficult for kids and vandals to get at.

One battery pack 14 can service many machines 10.

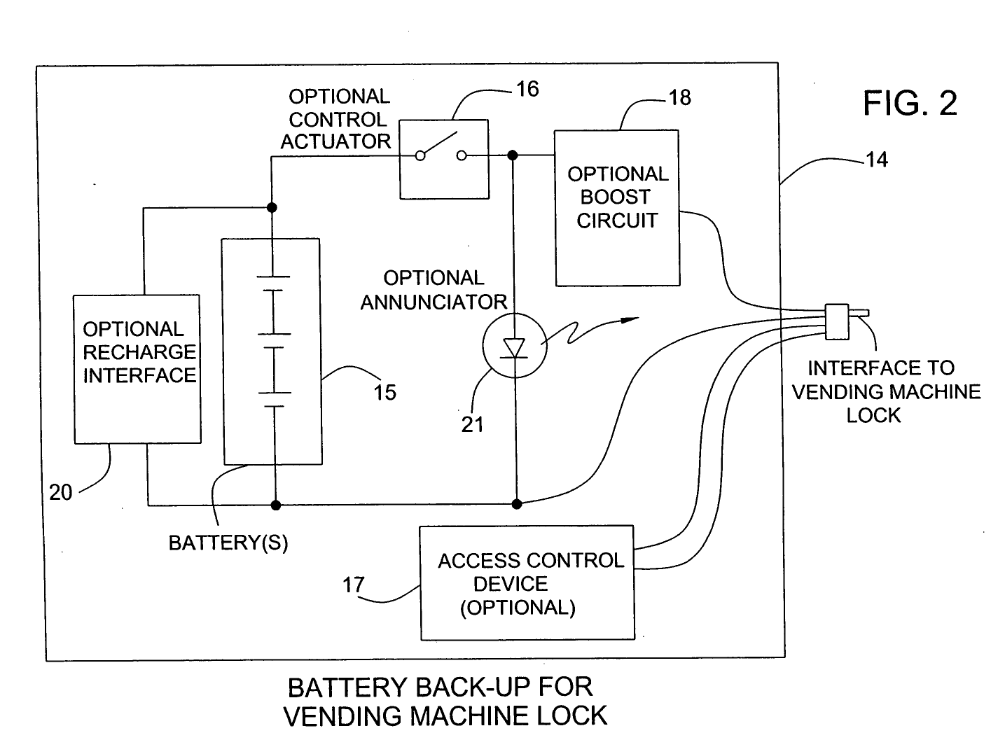

The back-up 14, FIG. 2, may consist of one or more batteries 15, either series or parallel or both configurations. The style, make, voltage, chemistry, etc., is not critical, except that batteries with higher in-rush current delivery are preferred such as alkaline, lead-acid, NiCad, etc.

The back-up 14 also contains an optional access control device 19 (such as an electronic key). Thus, if the primary access control interface is not functional, the back-up access device may be used.

The control actuator 16 is optional, but is preferred because assuming it is actuated only during operation (preferred operation) the power is only delivered to the lock when the actuator is closed during lock operation, thus saving battery power if the back-up is left plugged in before or remains plugged in after lock operation.

The boost circuit 18 is also optional, depending on the type of actuator used in the lock mechanism. If such actuator requires a boost voltage greater than typical battery voltages, a boost circuit would be required.

A recharge circuit 20 and an annunciator 21 are also shown as optional. If non-recharge batteries are used, than easy access to change the batteries is required. If re-chargeable batteries are used, the re-charge circuit would be included. The annunciator will display status of the power to the lock and/or the health of the power output.

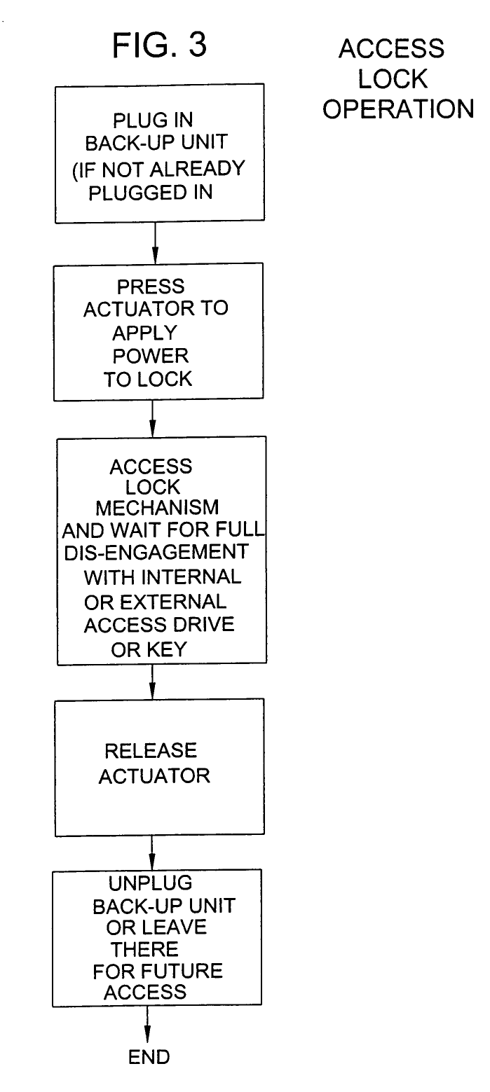

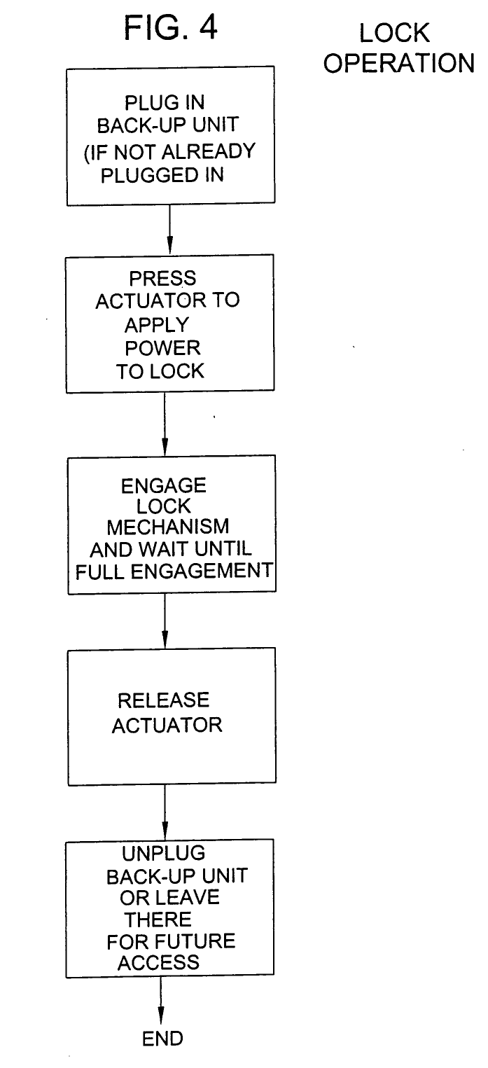

The locking and un-locking processes are described in FIGS. 3 and 4 which are flow charts depicting and stating the operational sequences involved.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A battery back-up power source for vending machine electronic locks comprising, a battery pack, connection means for interfacing said battery pack to a vending machine door carrying said electronic lock and means carried by said vending machine door adapted to receive said connection means whether the door is open or closed.

2. A battery back up, as claimed in claim 1, wherein a common interface is provided for a plurality of vending machines.

3. A battery back up as claimed in claim 1, wherein said battery pack includes a boost circuit to step up the voltage supplied to said lock.

4. A battery back up as claimed in claim 1, wherein said battery pack includes one or more of the following: a control switch to send electronic signals to the lock; a charging system; an enunciator or an access control.

5. A battery back-up power system for vending machine electronic locks comprising, a battery pack, connection means for interfacing said battery pack to a vending machine housing and door means carrying an electronic lock including motor driven locking means, and said electronic lock being independently actuable by a wireless electronic key.

6. A battery back-up as claimed in claim 5, wherein said connection means is receivable by an interface means on the vending machine housing and door means.

7. A battery back-up as claimed in claim 6, wherein said interface means is on the door and said door contains said motor drive for the locking means.

8. A battery back-up as claimed in claim 7, wherein said electronic lock is a motor driven bayonet coupling latch.

9. A battery back-up as claimed in claim 6, wherein said interface is common to a plurality of machine interfaces.

10. A battery back-up as claimed in claim 5, wherein said battery pack includes a boost circuit to step up the voltage supplied to said lock.

11. A battery back-up as claimed in claim 5, wherein said battery pack includes one or more of the following: a control switch to send electronic signals to the lock means; a charging system; an enunciator or an access control.

12. A battery back-up as claimed in claim 1, wherein said electronic lock is motor driven.

13. A battery back-up as claimed in claim 1, wherein said electronic lock is independently actuable by a wireless electronic key.
